(19) United States
(12) Patent Application Publication
(10) Pub. No.: US 2011/0172827 A1
(43) Pub. Date: Jul. 14, 2011

(54) CONTROL SYSTEM FOR A DOOR WING

(76) Inventor: Thomas Eichmann, Seuzach (CH)

(21) Appl. No.: 12/987,617

(22) Filed: Jan. 10, 2011

(30) Foreign Application Priority Data
Jan. 12, 2010 (DE) 10 2010 004 490.3

(51) Int. Cl. G05B 11/01

(52) U.S. Cl. 700/275

(57) ABSTRACT

In a process aimed at monitoring and controlling a wing door with radar sensors, while the radar sensors send signals and receive response signals, the response signals shall be transmitted to a central control unit, which incoming response signals (5.1, 6.1, 7.1) of the sensors (2, 3, 4) shall be processed in the control unit (9), while the wing door (1) shall be controlled by the control unit (9).

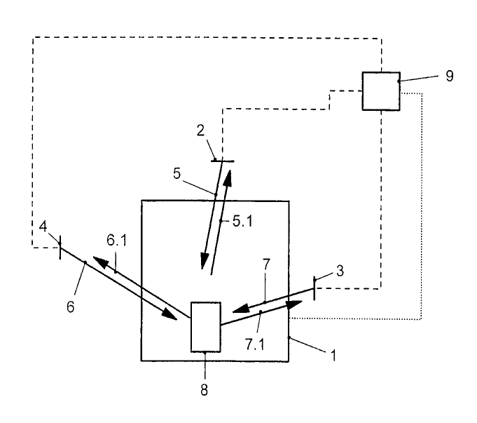

### BACKGROUND OF THE INVENTION

The invention herein presented is concerned with a process for monitoring and controlling a movable door wing as well as a device for accomplishing same.

As state of the art, a whole variety of control systems for the monitoring and controlling of door wings are known. For example, in DE 10 2008 008 149 A1,a device is known, the purpose of which is the control and/or the monitoring of at least one moveable wing, especially a door, a window, or the like, and which has the following features:
At least two sensor devices are included in the design;
To each one of these at least two sensor devices, a sensor field is correlated, in which a moving object is detectable by the sensor device;
In addition, an evaluation and/or control device and/or a signal processing unit, the purpose of which being the control and/or the monitoring of at least one wing under surveillance are included in the design, the defining characteristic of which is to be seen in the following features:
The at least two sensor fields are both, as far as size, position and/or form are concerned, designed differently, causing the first sensor field, which lies in a parallel orientation relative to the at least one wing under surveillance, to be broader than the second sensor field, which in turn is narrower than the first sensor field;
The evaluation and/or control device and/or the signal processing unit are configured in such a manner that the evaluation and/or monitoring of the at least one wing under surveillance is carried out in a differentiated manner, depending on the opening width of the wing configuration comprising of at least one wing and notably depending on a first or maximal opening width of the wing configuration or depending on an opening width, which, in a certain functional mode, is definable and diverts from or equals less than the first opening width.

According to the state of the art it is conventional wisdom that, where automatic door facilities are concerned, the area in front of the self-moving doors is kept under surveillance by sensors. Each one of these sensors has a separate detection unit and a processing unit each.

Another term for the deployed sensors is notion of a “motion detector”.

The surveillance systems known as state of the art employ the so-called double principle. According to said principle, a signal is emitted into a space and the signals reflected by a person or an object are detected by a sensor and processed duly. Due to the constant detection of these signals, the integrated processing unit decides whether the command to open the door should be given. Usually, the function of such motion detectors is based on ultrasonic waves, infrared rays or on the principle of radar.

Apart from such so-called “motion detectors”, so-called “state detectors” are also known as state of the art. The function of state detectors is based on passive infrared. Due to measurement of the radiation emitted by the sensors and detectors in the surveillance and trigger area a correlated evaluation and control of the door which is to open and close can be carried out depending on the changing intensity of the radiation. Finally, and for completeness, mention should be made of the so-called presence detectors, which are also known as state of the art and which function with light barriers of so-called CCD sensors. According to the current state of the art, all kinds of detectors and sensors mentioned here function alongside and parallel to each other.

They utilize different means for the surveillance for rooms and spaces, persons and objects. Each of these sensors and detectors has its own control unit that controls or monitors a door wing, all according to the function and the aim of the respective sensor or detector.

### SUMMARY OF THE INVENTION

The assignment underlying the invention is to provide as unified a design as possible, which shall be suitable for sensors, sensor facilities or general surveillance and detection devices, and especially for the control and surveillance of wing doors. At the same time, this system is to function on the basis of radar only and the evaluation of the respective emitters is to be as cost saving, effective and easily carried out as possible. In addition, a user friendly and easily handled configuration and application is to be achieved, simultaneously eliminating or at least alleviating the draw backs of the state of the art technology. Special emphasis is laid on the device being easy to set up and cheap to maintain, while also aiming at a significant improvement in flexibility of use.

The assignment is successfully completed, as far as the process is concerned, wherein sensors aimed at opening and shutting openings is monitored and controlled, wherein the sensors send signals and receive response signals, characterized in that
the response signals are transmitted to a central control unit,
the incoming response signals of the sensors are processed in the control unit,
   by which control unit the device aimed at shutting openings is controlled. As far as the device is concerned, at least two sensors are present, which monitor at least one device aimed at opening and shutting openings, characterized in that a control unit controls the device aimed at shutting openings.

Due to the utilization of a great variety of monitoring systems and sensors, each with its own respective calculation units, various sources of faults and failures are, as a matter of course, created, while the simultaneous and separate functioning of various systems and control units potentiate these sources of failure. In this context, the herein presented process is supposed to ensure that said sources of failure are eliminated due to the employment of one single control unit, which combines signals from any variety of sensors currently known as state of the art and which evaluates the respective signals and which controls the device aimed at opening and shutting of openings according to the calculation process.

The concept of a device aimed at opening and shutting of openings in accordance with the invention shall refer to all doors, wing doors and folding doors in simple or double embodiment. The concept of a device aimed at shutting openings shall also refer to sideways sliding doors as employed in the entrance and exit areas of department stores or other buildings. When in the context of the patent application a door is referred to, especially the device aimed at opening and shutting openings is explicitly to be understood as the meaning of the term.

In the reference frame of the herein presented invention, the concept of sensor shall comprise all sensors known as state of the art. Preferably, the term should refer to radar sensors. In another preferred embodiment, CCD sensors are included within the scope of the invention. In yet another preferred embodiment, infrared sensors or ultrasonic sensors shall be included within the scope of the invention. A combination of various or all sensors mentioned as preferred shall be included within the scope of the concept of a sensor.

To complete the process in accordance with the invention, at least two sensors and one control unit are needed. The herein lying advantage is that, until now, each sensor has had its own control unit. The cost for the control unit integrated into the sensor can now be economized.

The sensors no longer control the door; instead they merely transmit the response signals, which they receive from the area around the door, to the control unit. On the basis of the given parameters, the control unit decides whether to open the door or not.

The utilization of radar sensors has proven advantageous in that radar sensors are especially suitable for combining a large variety of characteristics. Thus, the monitoring, which according to the current state of the art has been carried out by various kinds of sensors, may in an advantageous manner be carried out by radar sensors only. The synchronization of all surveillance areas and systems thus diminishes the sources of failure and has the additional advantage of a simpler more cost effective maintenance, repairs and design.

The device in accordance with the invention has at least two sensors, which monitor one door and the area around the door. The transmission of the response signals to the control units can go via cable or wireless signals and be analogous or digital.

Then the control unit makes the decision whether the door should be opened or closed. To this end, it processes the given parameters. The herein lying advantage, on the other hand, is that only one control unit is necessary, even to serve more than one sensor.

The sensors are only assigned the function of mirrors which transmit the response signals to the control unit. It is the control unit which makes the final decision. A prejudged decision in the sensor, as is the case according to the state of the art, carries additional sources of failure. Thus, a design with fewer control units is advantageous. The number of sensors shall not be limited.

In a preferred embodiment, parameters are filed in the control unit. These parameters are adapted to the respective varieties of sensors. For instance, radar sensors require other parameters than infrared sensors. Upon the arrival of the respective parameters the control unit decides whether the door should be opened or not. This has the advantage that, due to the filing of certain parameters for certain kinds of sensors, faulty opening or shutting is eliminated.

In another preferred embodiment, these parameters are operated parallel to and in unison with each other for various kinds of sensors. This has, for instance, the advantage that sensors may be chosen to accommodate especially suitable operative fields and be operated accordingly.

In a preferred embodiment, the sensors have no more control units at all. The control unit is spatially positioned in a non-visible place and the sensors thus become much smaller and unobtrusive. This allows a better utilization in narrow spaces and a greater range of design choices for the user.

### BRIEF DESCRIPTION OF THE DRAWINGS

The invention is explained in detail with reference to the appended drawing, said drawing shows the following:

A schematic view of a device in accordance with the invention.

### DETAILED DESCRIPTION

The figure shows a wing door 1, which is supported [gelagert] in such a manner as to be movable sideways. This wing door 1 is monitored by three sensors 2, 3, 4. These sensors 2, 3, 4 send the signals 5, 6, 7 to an object 8.

This object 8 in turn sends response signals 5.1, 6.1, 7.1 back to the respective sensors 2, 3, 4. These in turn transmit the response signals they have received to a control unit 9. The transmission of the response signals 5.1, 6.1, 7.1 to the control unit 9 is here made visible schematically by interrupted lines. The control unit 9 then decides on the basis of the incoming response signals 5.1, 6.1, 7.1 whether the object 8 is stationary or in motion and whether the object, if in motion, is being moved through the wing door. Should the control unit 9, on the basis of the incoming response signals 5.1, 6.1, 7.1, perceive a movement of the object 9 towards the wing door 1, it will send to the wing door 1 the command “open”. The transmission of a command is signified in the figure by a dotted line. Should the object 8 be moving away from the wing door 1, the response signals 5.1, 6.1, 7.1 are, in this instance as well, led to the control unit 9 via the sensors 2, 3, 4, whereupon the control unit 9, on the basis of the incoming response signals 5.1, 6.1, 7.1, will decide to shut the wing door 1 again.

1. A process, by which a device with sensors (2, 3, 4) aimed at opening and shutting openings (1) is monitored and controlled, wherein the sensors (2, 3, 4) send signals (5, 6, 7) and receive response signals (5.1, 6.1, 7.1),
characterized in that
the response signals (5.1, 6.1, 7.1) are transmitted to a central control unit (9),
the incoming response signals (5.1, 6.1, 7.1) of the sensors (2, 3, 4) are processed in the control unit (9),
by which control unit (9) the device aimed at shutting openings (1) is controlled.

2. A process in accordance with claim 1, characterized in that, on the basis of the response signals (5.1, 6.1, 7.1), a distinction is made in the control unit (9) between moving and stationary objects (8).

3. A process in accordance with claim 2, characterized in that, on the basis of the response signals (5.1, 6.1, 7.1), a distinction is made in the control unit (9) between objects (8) and persons.

4. A process in accordance with claim 2, characterized in that, in the control unit (9), the response signals (5.1, 6.1, 7.1) of various sensors (2, 3, 4) are combined and processed.

5. A device aimed at completing a process in accordance with claim 1, characterized in that at least two sensors (2, 3, 4) are present, which monitor at least one device aimed at opening and shutting openings (1), characterized in that a control unit (9) controls the device aimed at shutting openings (1).

6. A device in accordance with claim 5, characterized in that the control unit (9) is present independently of the sensors (2, 3, 4).

7. A device in accordance with claim 5, characterized in that the sensors (2, 3, 4) send signals (5, 6, 7) and receive response signals (5.1, 6.1, 7.1).

8. A device in accordance with claim 5, characterized in that the transmission of the response signals (5.1, 6.1, 7.1) from the sensors (2, 3, 4) takes place via cable or a wireless connection.

9. A device in accordance with claim 5, characterized in that the sensors (2, 3, 4) are radar sensors and/or ultrasonic sensors and/or CCD sensors.

10. A device in accordance with claim 5, characterized in that the control unit (9) is deployable independently of the sensors (2, 3, 4).
